(19) United States
(12) Patent Application Publication
(10) Pub. No.: US 2026/0172131 A1
(43) Pub. Date: Jun. 18, 2026

(54) CLOCK SYNCHRONIZATION FOR MULTI-PARALLEL TRANSCEIVERS

(71) Applicant: MACOM Technology Solutions Holdings, Inc., Lowell, MA (US)

(72) Inventors: Ilhyun Cho, Yongin-si (KR); Hyunbae Jin, Seoul (KR); Kwangseok Han, Seongnam (KR); Heewon Suh, Seoul (KR); Kiwon Choi, Yongin-si (KR)

(21) Appl. No.: 18/982,516

(22) Filed: Dec. 16, 2024

(51) Int. Cl. H04J 3/06

(52) U.S. Cl. CPC H04J 3/0638

(57) ABSTRACT

Aspects of a system for clock synchronization for multi-parallel transceivers are described. An example system includes a memory device and a plurality of transceivers in data communication with the memory device, where each transceiver of the plurality of transceivers operates with a calibration offset from each other. Each transceiver includes a first phase circuit configured to receive an input clock signal and a second phase circuit configured to receive an output clock signal transmitted from the first phase circuit. The second phase circuit is configured to perform a comparison of the input clock signal with a reference clock signal and generate an output signal based on the comparison. Additionally, the first phase circuit is configured to generate a calibrated output clock signal based on the output signal, where the calibrated output clock signal is phase aligned with the reference clock signal.

### BACKGROUND

Transceivers are important communication components used to transmit and receive data in high-speed electronic systems. They serve as an interface for high-bandwidth data transfer between components, enabling them to be used in applications involving memory devices for high-performance computing, gaming, and artificial intelligence (AI). Transceivers operate generally with calibration offsets from one another, potentially creating data misalignment and synchronization issues. Synchronizing transceivers to eliminate or mitigate the data misalignment or synchronization issues is important in some cases to ensure data is transmitted in the manner desired by an application.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

Aspects of clock synchronization for multi-parallel transceivers are described herein. An example transceiver includes a first phase circuit configured to receive an input clock signal and a second phase circuit configured to receive an output clock signal transmitted from the first phase circuit, where the output clock signal is generated based on the input clock signal. The second phase circuit is configured to perform a comparison of the input clock signal with a reference clock signal and generate an output signal based on the comparison. The first phase circuit is configured to generate a calibrated output clock signal based on the output signal, where the calibrated output clock signal is phase aligned with the reference clock signal.

Aspects of a system for clock synchronization for multi-parallel transceivers are described herein. An example system includes a memory device and a plurality of transceivers in data communication with the memory device, where each transceiver of the plurality of transceivers operates with a calibration offset from each other. Each transceiver includes a first phase circuit configured to receive an input clock signal and a second phase circuit configured to receive an output clock signal transmitted from the first phase circuit, where the output clock signal is generated based on the input clock signal. The second phase circuit is configured to perform a comparison of the input clock signal with a reference clock signal and generate an output signal based on the comparison. Additionally, the first phase circuit is configured to generate a calibrated output clock signal based on the output signal, where the calibrated output clock signal is phase aligned with the reference clock signal.

Another example system includes a memory device, a memory device and a plurality of transceivers in data communication with the memory device, where each transceiver of the plurality of transceivers operates with a calibration offset from each other. Each transceiver includes a first phase circuit configured to receive an input clock signal and a second phase circuit configured to receive an output clock signal transmitted from the first phase circuit, where the output clock signal is generated based on the input clock signal. The second phase circuit is configured to perform a comparison of the input clock signal with a reference clock signal and generate an output signal based on the comparison. Additionally, the first phase circuit is configured to generate a calibrated output clock signal based on the output signal, where the calibrated output clock signal is phase aligned with the reference clock signal. The system further includes a synchronization logic configured to receive the output signal from the second phase circuit of each transceiver and control the first phase circuit of each transceiver for generating the calibrated output clock signal.

### BRIEF DESCRIPTION OF THE DRAWINGS

Aspects of the present disclosure can be better understood with reference to the following drawings. It is noted that the elements in the drawings are not necessarily drawn to scale, with emphasis instead being placed upon illustrating the principles of the examples. In the drawings, like reference numerals designate like or corresponding, but not necessarily the same, elements throughout the several views.

FIG. 1 depicts an example system for synchronization of parallel transceivers according to various embodiments of the present disclosure.

FIG. 2 depicts a timing diagram of various clock signals that can be generated by the system shown in FIG. 1 according to various embodiments of the present disclosure.

FIG. 3 depicts a series of waveforms of various clock signals that can be generated by the system shown in FIG. 1 according to various embodiments of the present disclosure.

FIG. 4A depicts a series of waveforms of various clock signals and a reset signal that can be generated by the system shown in FIG. 1, and FIG. 4B depicts before-calibration waveforms and after-calibration waveforms of various clock signals that can be generated by the system shown in FIG. 1, according to various embodiments of the present disclosure.

FIG. 5 depicts an example method for clock synchronization of multi-parallel transceivers according to various embodiments of the present disclosure.

### DETAILED DESCRIPTION

Memory devices are being designed to meet increasing demands for higher bandwidth and data transfer rates as compared to prior generations for graphics and computing applications. New memory devices are designed to support high bandwidth and reliable data transfer for use in applications such as graphics cards, game consoles, and other high-performance computing applications. In a memory device, various bus lanes can be used to receive and return data. However, the receipt and return of data by the memory device can be prone to phase alignment issues, which can cause reliability issues for the memory device.

A memory device can include multi-bit input and output (I/O) pins, which enable the memory device to transfer multiple bits of data simultaneously through multiple I/O pins or channels. For example, if a memory device has an 8-bit I/O interface, the memory device can be configured to transfer 8 bits of data in parallel during a clock cycle. This parallelism can significantly increase the data transfer rate compared to a single-bit I/O interface. In this context, a controller generally needs to be synchronized for each bit of the memory device for effective communication.

Memory devices operating at high data rates with larger numbers of I/O pins can introduce synchronization issues for multi-bit data. As data rates increase, the importance of aligning skew between data can become progressively more significant. Additionally, as the number of I/O pins increase, matching or aligning the skew between the I/Os can become increasingly challenging for multi-bit I/O systems operating with high data rates on printed circuit boards (PCBs).

A high data rate multi-bit I/O system can include several transceivers, each equipped with a serializer and a de-serializer (SERDES). Such systems can face synchronization issues between the transceivers in a similar fashion as explained above with respect to the memory devices. A frequency divider can be used for de-serializing, but the initial state of frequency is not defined without a reset signal. The synchronization of reset signals for multiple transceivers should be synchronized between each of the multiple transceivers to eliminate the calibration offset that can exist between each of the transceivers during operation.

Clock synchronization concepts and approaches for multi-parallel transceivers are described herein. An example system for clock synchronization for multi-parallel transceivers includes a memory device and a plurality of transceivers in data communication with the memory device. In the system, each transceiver operates with a calibration offset from each other, and each transceiver includes a first phase circuit configured to receive an input clock signal and a second phase circuit configured to receive an output clock signal transmitted from the first phase circuit. The output clock signal is generated based on the input clock signal, and the second phase circuit is configured to perform a comparison of the input clock signal with a reference clock signal and generate an output signal based on the comparison. The first phase circuit is configured to generate a calibrated output clock signal based on the output signal, where the calibrated output clock signal is phase aligned with the reference clock signal.

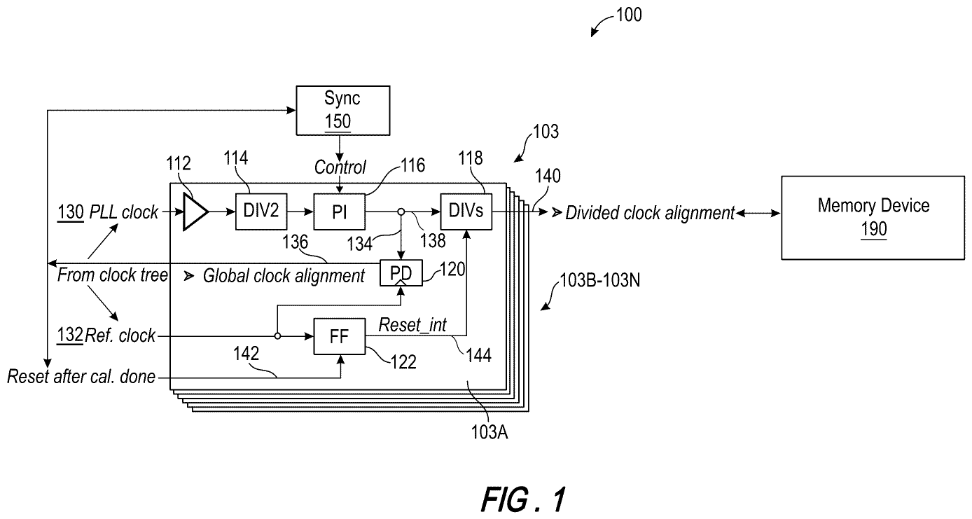

Referring now to the drawings, FIG. 1 depicts an example system 100 for synchronization of parallel transceivers according to various embodiments of the present disclosure. The system 100 is not exhaustively illustrated, meaning that other components not shown in FIG. 1 can be included or relied upon in some cases. Similarly, one or more components shown in FIG. 1 can be omitted in some cases. The system 100 is representative of a multi-bit I/O system including multiple transceivers, with each transceiver possibly equipped with a SERDES for data communication with a memory device. As depicted, the system 100 includes transceivers 103 (representative of multiple transceivers in data communication with one another), a memory device 190 in data communication with the transceivers 103, and a synchronization logic 150.

The memory device 190 can include a graphics memory device such as graphics double data rate (GDDR) memory, high bandwidth memory (HBM), low power double data rate memory (LPDDR), double data rate (DDR) memory, magnetoresistive random-access memory (MRAM), and static random-access memory, among other types of memory.

The synchronization logic 150 can be configured to control the synchronization of clock signals of each of the transceivers 103. For example, the synchronization logic 150 can be configured to control clock alignment, phase adjustment, and perform other synchronization tasks associated with controlling the transceivers 103. As such, the synchronization logic 150 can be embodied as a controller for controlling the timing and alignment of operations within the transceivers 103.

The transceivers 103 can include multiple transceivers (e.g., transceiver 103A-103N). The number of the transceivers 103 can be determined based on data channel requirements of the memory device 190, type of application using the system 100, specifications of the memory device 190 and/or the transceivers 103, and other factors. Each of the transceivers 103 can be connected in parallel to the memory device 190. In the description provided below, the components, function, and synchronization of each of the transceivers 103 are described with respect to the transceiver 103A. The transceivers 103B-103N are other transceivers of the transceivers 103 and include generally the same components as the transceiver 103A.

The transceiver 103A is representative of a single transceiver among the transceivers 103. The transceiver 103A includes a buffer 112, a clock divider 114, a first phase circuit 116, a clock divider 118, a second phase circuit 120, and a logic device 122 in the example shown. The first phase circuit 116 can include a phase interpolator (PI), a phase shifter, or related circuitry. The second phase circuit 120 can include a phase detector (PD), a phase comparator, or related circuitry. The logic device 122 can include a flip-flop or other logic devices such as latches or registers that can perform similarly to a flip-flop. The transceiver 103A is depicted as a representative example. In other cases the transceiver 103A can include additional components or omit one or more of the components shown in FIG. 1.

Without coordinated control, each of the transceivers 103 may intrinsically operate with one or more phase-related offsets from each other. The offsets can cause or introduce skew among the transceivers 103, because the offsets result in differences in the timing or phase alignment of signals transmitted or received by the transceivers 103. For example, each of the transceivers 103 can be equipped with a SERDES that can facilitate data flow to and from the memory device 190. A phase offset or a clock skew can introduce or cause skew during parallel data transfer between the transceivers 103 and the memory device 190, leading to bit errors in some cases. Thus, the embodiments described herein are directed to synchronizing each of the transceivers 103, so that the transceiver 103A, for example, generates a synchronized or aligned clock signal from the clock divider 118 with respect to the remaining transceivers 103B-103N, thereby reducing or eliminating the skew described above.

To synchronize or phase align the transceivers 103 among each other, an input clock signal 130, which can be a phase-locked loop (PLL) clock signal originating from a clock tree, is fed through the buffer 112, the clock divider 114, and to the first phase circuit 116. A reference clock signal 132, which can be a reference clock signal originating from a clock tree, is fed to the second phase circuit 120. The second phase circuit 120 is configured to receive an output clock signal 134 transmitted from the first phase circuit 116, where the first phase circuit 116 is configured to generate the output clock signal 134 based on the input clock signal 130. The second phase circuit 120 is configured to perform a comparison of the input clock signal 130 with the reference clock signal 132 and generate an output signal 136 based on the comparison. For example, the second phase circuit 120 can determine whether the input clock signal 130 is phase shifted versus the reference clock signal 132 and generate the output signal 136 which can contain a signal that corrects or identifies the phase misalignment of the output clock signal 134 versus the reference clock signal 132.

The second phase circuit 120 is configured to transmit the output signal 136 to the synchronization logic 150, and the synchronization logic 150 is configured to control the first phase circuit 116 to cause the first phase circuit 116 to generate a calibrated output clock signal that is synchronized or phase aligned with the reference clock signal 132 based on the output signal 136. Thus, based on the control of the synchronization logic 150, the first phase circuit 116 is configured to generate a calibrated output clock signal 138 that is synchronized or phase aligned with the reference clock signal 132. The generation of the calibrated output clock signal 138 can mark the end of a first calibration step of the input clock signal 130.

In practice or during operation, the calibrated output clock signal generated for each of the transceivers 103 may be offset in phase (e.g., not phase-aligned) from each other once passed through each respective clock divider (e.g., the clock divider 118). Reset signals provided to each of the transceivers 103 can be relied upon to initialize each of the clock dividers in the transceivers 103. Depending on the timing of the reset signals, the signals can introduce delays or offsets to the output signals of the respective clock dividers among the transceivers 103. Thus, the reset signals transmitted to the respective clock dividers of the transceivers 103 can also require synchronization, so that the outputs of the respective clock dividers are synchronized or phase aligned with each other. The calibration process of the reset signals, as directed by the synchronization logic 150, is described below.

The synchronization logic 150 is configured to generate multiple reset signals for transmission to the transceivers 103. For example, if the transceivers 103 include twenty (20) transceivers, the synchronization logic 150 can be configured to generate twenty (20) reset signals for the transceivers 103. In the context of the transceiver 103A, the synchronization logic 150 is configured to generate a reset signal 142 and transmit the reset signal 142 to the logic device 122. The logic device 122 is configured to synchronize the reset signal 142 with the reference clock signal 132 to generate a synchronized reset signal 144 that is transmitted to the clock divider 118.

The first phase circuit 116 is configured to transmit the calibrated output clock signal 138 to the clock divider 118, and the clock divider 118 can be configured to generate a divided output clock signal 140 based on the synchronized reset signal 144 and the calibrated output clock signal 138. The divided output clock signal 140 is synchronized with the reference clock signal 132 via the synchronized reset signal 144. The clock divider 118 can be configured to divide or reduce the frequency of the calibrated output clock signal 138 by a fraction of one-sixteenth ( 1/16) of the frequency of the calibrated output clock signal 138 in generating the divided output clock signal 140. For example, the calibrated output clock signal 138 can have a frequency of 10 GHz and the divided output clock signal can have a frequency of 0.625 GHz, which is one-sixteenth of 10 GHz. However, it should be noted that the frequencies output by the first phase circuit 116 and the clock divider 118 can vary and other ratios for frequency division are contemplated within the scope of this disclosure.

Each of the transceivers 103 is configured to generate a divided output clock signal as described above. Based on the respective synchronized reset signals (e.g., the synchronized reset signal 144), each divided output clock signal for the transceivers 103 can be synchronized or phase aligned with the reference clock signal 132. As such, within a given period or a partial period, each rising edge or each falling edge of each divided output clock signal for the transceivers 103 can trigger at the same time, ensuring synchronization of each of the transceivers 103. Referring back to the transceiver 103A, the divided output clock signal 140 can facilitate serialization or deserialization for parallel data transfer between the transceivers 103 and the memory device 190.

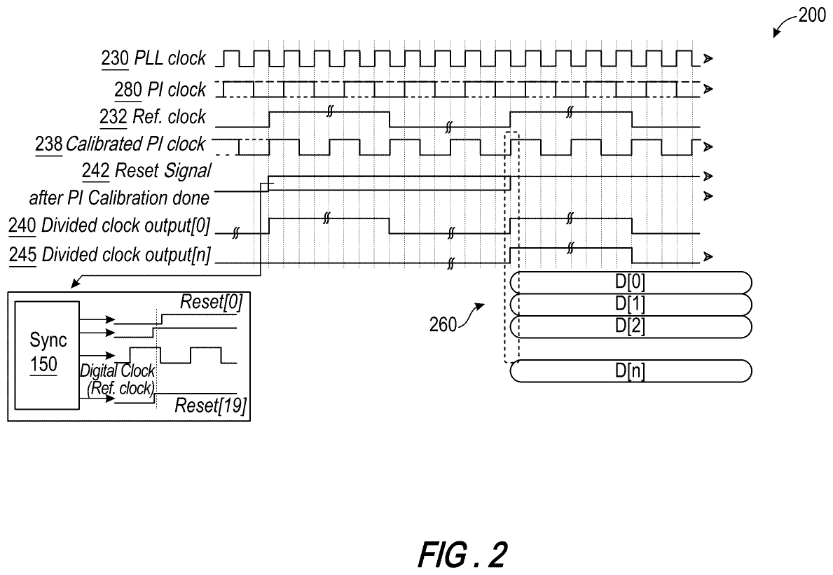

FIG. 2 depicts a timing diagram of various clock signals that can be generated by the system 100 according to various embodiments of the present disclosure. Timing diagram 200 includes an input clock signal 230 (e.g., “PLL clock”), an output clock signal 280 (e.g., “PI clock”), a reference clock signal 232, a calibrated output clock signal 238 (e.g., “Calibrated PI clock”), a reset signal 242, a first divided output clock signal 240, and a second divided output clock signal 245. The input clock signal 230, the output clock signal 280, the reference clock signal 232, the calibrated output clock signal 238, the calibrated output clock signal 238, the reset signal 242, the first divided output clock signal 240, and the second divided output clock signal 245 are signals that can be generated by one or more of the components of each of the transceivers 103 of the system 100. For example, the input clock signal 230 can correspond to the input clock signal 130, the reference clock signal 232 can correspond to the reference clock signal 132, the calibrated output clock signal 238 can correspond to the calibrated output clock signal 138, the reset signal 242 can correspond to the reset signal 142, and the first divided output clock signal 240 can correspond to the divided output clock signal 140. The output clock signal 280 generally corresponds to a clock signal that can be generated by the first phase circuit 116 before the first calibration step described above is performed. For example, the output clock signal 280 is a clock signal output by the first phase circuit 116 that is not phase aligned with the reference clock signal 132.

The input clock signal 230 is representative of an input clock signal that can be distributed from a PLL to each of the transceivers 103. As described above, before the first calibration step is performed by the system 100, an output clock signal (e.g., the output clock signal 280) generated by the first phase circuit 116 is not phase aligned with the reference clock signal 132. Referring to the timing diagram 200, the output clock signal 280 is not phase aligned with the reference clock signal 232. In the example shown, the rising edge of the output clock signal 280 does not turn on or get activated at the same time as the rising edge of the reference clock signal 232. After the first calibration step, however, the calibrated output clock signal 138 generated by the first phase circuit 116 is phase aligned with the reference clock signal 132. Looking at the timing diagram 200, the calibrated output clock signal 238 is phase aligned with the reference clock signal 232. In other words, the rising edge of the calibrated output clock signal 238 turns on or is activated at the same time as the rising edge of the reference clock signal 232.

Additionally, after completion of the first calibration step, the synchronization logic 150 is configured to generate and transmit reset signals to each of the transceivers 103. In the example shown in FIG. 2, the synchronization logic 150 is configured to generate twenty reset signals Reset[0]-Reset[19], one for each of the transceivers 103. An example reset signal that can be generated by the synchronization logic 150 and transmitted to a logic device (e.g., the logic device 122 shown in FIG. 1) is indicated by the reset signal 242. In an exemplary use case, as described above, the logic device 122 is configured to synchronize the reset signal 242 with the reference clock signal 232 to generate a synchronized reset signal (e.g., the synchronized reset signal 144) that is transmitted to, for example, the clock divider 118. It should be noted that there is generally no metastability issue for the reset signal 242 because higher frequencies (e.g., the calibrated output clock signal 238) generated by the system 100 are aligned to the reference clock signal 232, and the reference clock signal 232 is generally the lowest frequency generated by the transceivers 103.

The first divided output clock signal 240 is a divided output clock signal that can be generated by, for example, the clock divider 118. The first divided output clock signal 240 is synchronized with the reference clock signal 232. Additionally, the first divided output clock signal 240 is synchronized with the calibrated output clock signal 238, as can be seen from boxed area 260 on the timing diagram 200. The second divided output clock signal 245 is a divided output clock signal that can be generated by the other transceivers 103B-103N of the system 100. As described above in connection with the description of the system 100, each divided output clock signals of the transceivers 103 is synchronized with each other based on the synchronized reset signals. The timing diagram 200 shows that the second divided output clock signal 245 is synchronized or aligned with the first divided output clock signal 240.

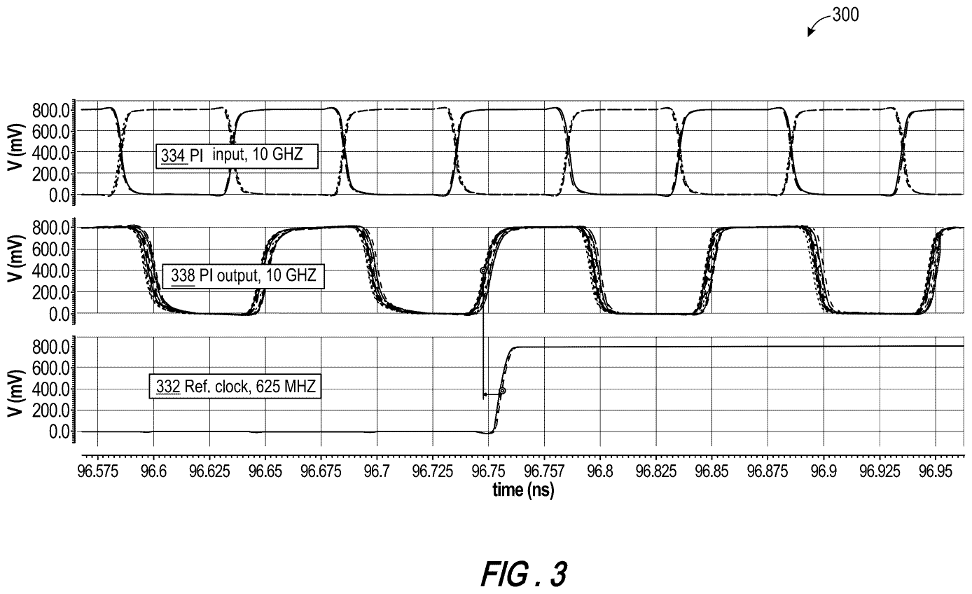

FIG. 3 depicts a series of waveforms of various clock signals that can be generated by the system 100 according to various embodiments of the present disclosure. Waveforms 300 correspond to a Monte Carlo simulation that was executed via a test bench setup which implements the system 100. The waveforms 300 include a waveform for a clock signal 334 (e.g., “PI input”), a calibrated output clock signal 338 (e.g., “PI output”), and a reference clock signal 332. The clock signal 334 corresponds to the input clock signal 230 and the output clock signal 280 which have been overlayed on top of each other. The clock signal 334 is not aligned or synchronized with the reference clock signal 332, which corresponds to the reference clock signal 232, for example. The calibrated output clock signal 338 corresponds to the calibrated output clock signal 238 and is phase aligned or synchronized with the reference clock signal 332. For example, the rising edge of the calibrated output clock signal 338 turns on or is activated at the same time as the rising edge of the reference clock signal 332.

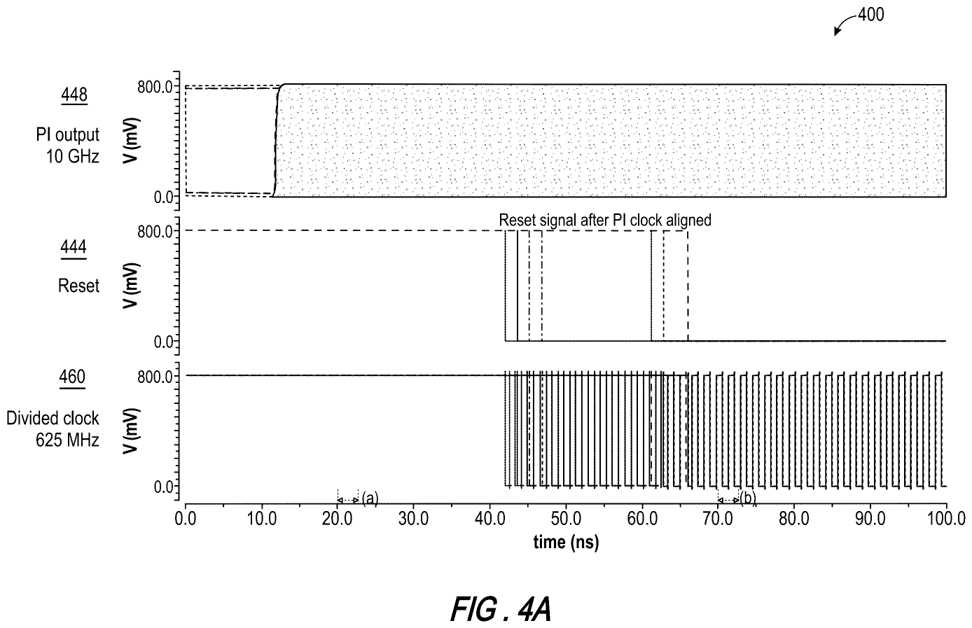

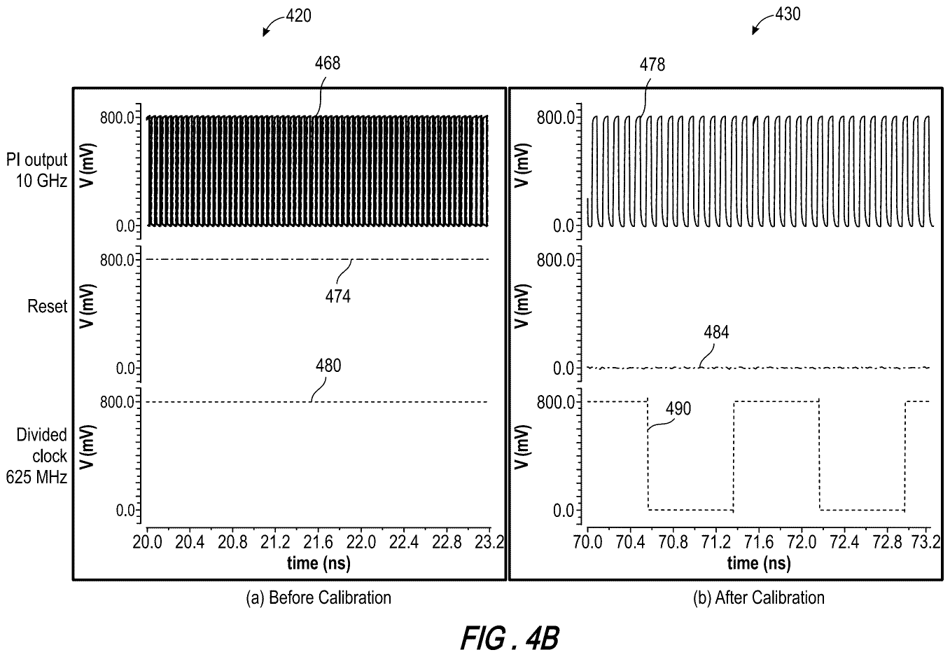

FIG. 4A depicts a series of waveforms of various clock signals and a reset signal that can be generated by the system 100, and FIG. 4B depicts before-calibration waveforms and after-calibration waveforms of various clock signals that can be generated by the system 100, according to various embodiments of the present disclosure. Waveforms 400 in FIG. 4A correspond to a Monte Carlo simulation that was executed according to an ideal scenario including the system 100 without accounting for parasitic effects which may be present in the system 100. The waveforms 400 include a waveform for a calibrated output clock signal 448, a synchronized reset signal 444, and divided output clock signals 460. The calibrated output clock signal 448 can correspond to the calibrated output clock signal 138, and the synchronized reset signal 444 can correspond to the synchronized reset signal 144. The divided output clock signals 460 can correspond to divided output clock signals of multiple transceivers (e.g., 103A-103N) that have been overlayed on top of each other. Upon implementation of the synchronized reset signal 444, which can occur after the generation of the calibrated output clock signal 448, the divided output clock signals 460 are phase aligned with each other. Additionally, the divided output clock signals 460 and the calibrated output clock signal 448 are phase aligned.

Waveforms 420 in FIG. 4B correspond to a before-calibration Monte Carlo simulation of an output clock signal 468, a reset signal 474, and a divided output clock signal 480. Waveforms 430 in FIG. 4B correspond to an after-calibration Monte Carlo simulation of a calibrated output clock signal 478, a synchronized reset signal 484, and a divided output clock signal 490. For example, after the calibration steps described with respect to FIG. 1 for the system 100 is performed, the calibrated output clock signal 478, the synchronized reset signal 484, and the divided output clock signal 490 can be generated. In the waveforms 420, the output clock signal 468 is not calibrated, similar to as described for the output clock signal 134. Additionally, the reset signal 474 is not synchronized with a reference clock signal (e.g., the reference clock signal 132), and thus, the divided output clock signal 480 is not calibrated or synchronized with a reference clock signal.

In the waveforms 430, the calibrated output clock signal 478 can correspond to the calibrated output clock signal 138, the synchronized reset signal 484 can correspond to the synchronized reset signal 144, and the divided output clock signal 490 can correspond to the divided output clock signal 140. In other words, the calibrated output clock signal 478 has been synchronized with a reference clock signal (e.g., the reference clock signal 132), and the divided output clock signal 490 has been synchronized with the reference signal via the synchronized reset signal 484. Thus, the divided output clock signal 490 and the calibrated output clock signal 478 are phase aligned.

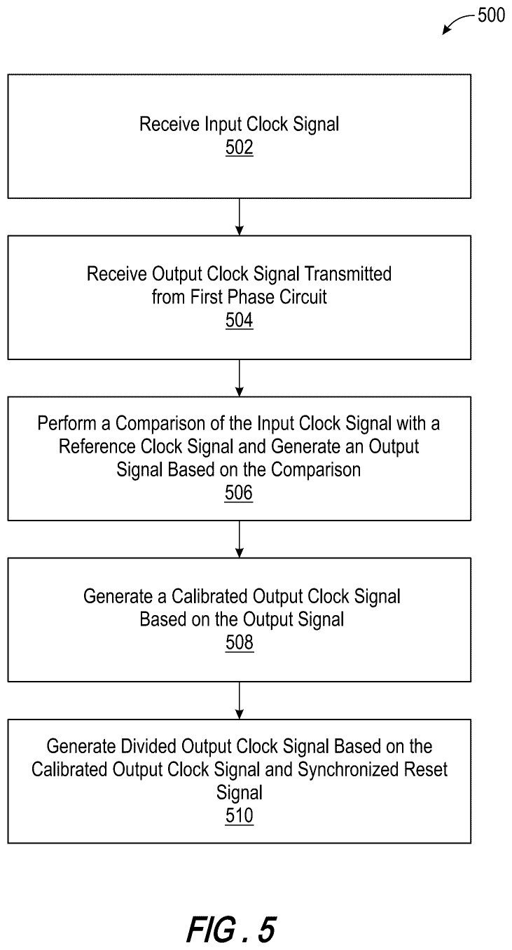

FIG. 5 depicts an example method for clock synchronization of multi-parallel transceivers according to various embodiments of the present disclosure. Method 500 can be implemented in the system 100 shown in FIG. 1, for example, although the method can be implemented in other systems. At step 502, the method 500 includes receiving an input signal. For example, in the system 100, the first phase circuit 116 can be configured to receive the input clock signal 130 via the buffer 112 and the clock divider 114. The reference clock signal 132 can be additionally transmitted to the second phase circuit 120 from a clock tree.

At step 504, the method 500 includes receiving an output clock signal transmitted from a first phase circuit. For example, the second phase circuit 120 can be configured to receive the output clock signal 134 transmitted from the first phase circuit 116, where the first phase circuit 116 is configured to generate the output clock signal 134 based on the input clock signal 130.

At step 506, the method 500 includes performing a comparison of an input clock signal with a reference clock signal and generating an output signal based on the comparison. For example, the second phase circuit 120 can be configured to perform a comparison of the input clock signal 130 with the reference clock signal 132 and generate the output signal 136 based on the comparison. The second phase circuit 120 can be configured to determine whether the input clock signal 130 is phase shifted versus the reference clock signal 132 and generate the output signal 136 which can contain a signal that corrects or identifies the phase misalignment of the output clock signal 134 versus the reference clock signal 132.

At step 508, the method 500 includes generating a calibrated output clock signal based on an output signal. For example, the first phase circuit 116 can be configured to generate the calibrated output clock signal 138. The second phase circuit 120 can be configured to transmit the output signal 136 to the synchronization logic 150, and the synchronization logic 150 can be configured to control the first phase circuit 116 to cause the first phase circuit 116 to generate the calibrated output clock signal 138 that is synchronized or phase aligned with the reference clock signal 132, based on the output signal 136. The completion of step 508 can mark the end of the first calibration step.

At step 510, the method 500 includes generating a divided output clock signal based on a calibrated output clock signal and a synchronized reset signal. For example, the clock divider 118 can be configured to generate the divided output clock signal 140 based on the calibrated output clock signal 138 and the synchronized reset signal 144. The divided output clock signal 140 can be synchronized with the reference clock signal 132 via the synchronized reset signal 144. The clock divider 118 can be configured to divide or reduce the frequency of the calibrated output clock signal 138 by a fraction of one-sixteenth ( 1/16) of the frequency of the calibrated output clock signal 138 in generating the divided output clock signal 140, although other ratios for division or reducing the frequency can be relied upon. For example, the calibrated output clock signal 138 can have a frequency of 10 GHz and the divided output clock signal can have a frequency of 0.625 GHz, which is one-sixteenth of 10 GHz. However, it should be noted that the frequencies output by the first phase circuit 116 and the clock divider 118 can vary and other ratios for frequency division are contemplated within the scope of this disclosure. After the divided output clock signal 140 is generated, the synchronization logic can be configured to turn off the reference clock signal 132, thereby reducing or eliminating a source of noise or parasitic effects for the system 100.

It should be noted that each of the transceivers 103 can be configured to perform the calibration steps described above to generate a divided output clock signal, for multi-parallel clock synchronization, thereby correcting misalignment or skew that may be present among the transceivers 103. The divided output clock signals (e.g., the divided output clock signal 140) can be aligned or synchronized to a reference clock and facilitate serialization or deserialization for parallel data transfer between the transceivers 103 and the memory device 190, enabling accurate data synchronization for the system 100.

The embodiments described herein for clock synchronization for multi-parallel transceivers can address skew that may be intrinsically present in transceivers of a parallel data transfer system. The embodiments enable clock synchronization of each transceiver of a system to a reference clock signal, thereby reducing or eliminating the skew described above.

The concepts described herein can be combined in one or more embodiments in any suitable manner, and the features discussed in the embodiments are interchangeable in some cases. Example embodiments are described herein, although a person of skill in the art will appreciate that the technical solutions and concepts can be practiced in some cases without all of the specific details of each example. Additionally, substitute or equivalent steps, components, materials, and the like may be employed.

The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Although relative terms such as “on,” “below,” “upper,” “lower,” “top,” “bottom,” “right,” and “left” may be used to describe the relative spatial relationships of certain structural features, these terms are used for convenience only, as a direction in the examples. Thus, if a structure is turned upside down, the “upper” component will become a “lower” component. When a structure or feature is described as being “on” (or formed on) another structure or feature, the structure can be positioned directly on (i.e., contacting) the other structure, without any other structures or features intervening between the structure and the other structure. When a structure or feature is described as being “over” (or formed over) another structure or feature, the structure can be positioned over the other structure, with or without other structures or features intervening between them. When two components are described as being “coupled to” each other, the components can be electrically coupled to each other, with or without other components being electrically coupled and intervening between them. When two components are described as being “directly coupled to” each other, the components can be electrically coupled to each other, without other components being electrically coupled between them.

Terms such as “a,” “an,” “the,” and “said” are used to indicate the presence of one or more elements and components. The terms “comprise,” “include,” “have,” “contain,” and their variants are used to be open ended and may include or encompass additional elements, components, etc., in addition to the listed elements, components, etc., unless otherwise specified. The terms “first,” “second,” etc. may be used as differentiating identifiers of individual or respective components among a group thereof, rather than as a descriptor of a number of the components, unless clearly indicated otherwise.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or metric of deviation, account for at least some manufacturing tolerances between a theoretical design and a manufactured product or assembly. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

Therefore, the following is claimed:

1. A transceiver, comprising:
a first phase circuit configured to receive an input clock signal; and
a second phase circuit configured to receive an output clock signal transmitted from the first phase circuit, the output clock signal generated based on the input clock signal, wherein:
the second phase circuit is configured to perform a comparison of the input clock signal with a reference clock signal and generate an output signal based on the comparison; and
the first phase circuit is configured to generate a calibrated output clock signal based on the output signal, the calibrated output clock signal being phase aligned with the reference clock signal.

2. The transceiver of claim 1, further comprising a synchronization logic configured to receive the output signal from the second phase circuit and control the first phase circuit for generating the calibrated output clock signal.

3. The transceiver of claim 2, further comprising a clock divider configured to receive and divide a frequency of the calibrated output clock signal to generate a divided output clock signal.

4. The transceiver of claim 3, wherein the transceiver comprises a serializer and a de-serializer (SERDES) for data transfer to a memory device, the SERDES configured to serialize or deserialize data for parallel date transfer based on the divided output clock signal.

5. The transceiver of claim 3, wherein the synchronization logic is further configured to turn off the reference clock signal after the divided output clock signal is generated.

6. The transceiver of claim 1, wherein:
the input clock signal is a phase-locked loop (PLL) clock signal; and
the reference clock signal and the input clock signal are transmitted from a clock tree.

7. The transceiver of claim 3, further comprising a logic device coupled to the clock divider, the logic device configured to receive the reference clock signal and a reset signal from the synchronization logic and generate a synchronized reset signal based on the reference clock signal, the synchronized reset signal being used to phase align the divided output clock signal to additional divided output clock signals generated by additional transceivers.

8. The transceiver of claim 7, wherein:
the first phase circuit is a phase interpolator;
the second phase circuit is a phase detector; and
the logic device is a flip flop.

9. A system, comprising:
a memory device; and
a plurality of transceivers in data communication with the memory device, wherein each transceiver of the plurality of transceivers operates with a calibration offset from each other and each transceiver comprises:
a first phase circuit configured to receive an input clock signal;
a second phase circuit configured to receive an output clock signal transmitted from the first phase circuit, the output clock signal generated based on the input clock signal, wherein:
the second phase circuit is configured to perform a comparison of the input clock signal with a reference clock signal and generate an output signal based on the comparison; and
the first phase circuit is configured to generate a calibrated output clock signal based on the output signal, the calibrated output clock signal being phase aligned with the reference clock signal.

10. The system of claim 9, further comprising a synchronization logic configured to receive the output signal from the second phase circuit of each transceiver and control the first phase circuit of each transceiver for generating the calibrated output clock signal.

11. The system of claim 10, wherein each transceiver further comprises:
a clock divider configured to receive and divide a frequency of the calibrated output clock signal; and
a logic device communicatively coupled between the second phase circuit and the clock divider and configured to receive the reference clock signal and a reset signal and generate a synchronized reset signal based on the reference clock signal.

12. The system of claim 11, wherein:
the clock divider of each transceiver is configured to receive the synchronized reset signal; and
the clock divider of each transceiver is configured to generate a divided output clock signal based on the synchronized reset signal and the calibrated output clock signal.

13. The system of claim 12, wherein the divided output clock signal for each transceiver is phase aligned with the reference clock signal.

14. The system of claim 12, wherein the synchronization logic is further configured to turn off the reference clock signal after the divided output clock signal is generated.

15. The system of claim 12, wherein each transceiver comprises a serializer and a de-serializer (SERDES) for data transfer to the memory device, the SERDES configured to serialize or deserialize data for parallel date transfer based on the divided output clock signal.

16. The system of claim 11, wherein for each transceiver:
the first phase circuit is a phase interpolator;
the second phase circuit is a phase detector; and
the logic device is a flip flop.

17. A system, comprising:
a memory device;
a plurality of transceivers in data communication with the memory device, wherein each transceiver of the plurality of transceivers operates with a calibration offset from each other and each transceiver comprises:
a first phase circuit configured to receive an input clock signal;
a second phase circuit configured to receive an output clock signal transmitted from the first phase circuit, the output clock signal generated based on the input clock signal, wherein:
the second phase circuit is configured to perform a comparison of the input clock signal with a reference clock signal and generate an output signal based on the comparison; and
the first phase circuit is configured to generate a calibrated output clock signal based on the output signal, the calibrated output clock signal being phase aligned with the reference clock signal; and
a synchronization logic configured to receive the output signal from the second phase circuit of each transceiver and control the first phase circuit of each transceiver for generating the calibrated output clock signal.

18. The system of claim 17, wherein each transceiver further comprises:
a clock divider configured to receive and divide a frequency of the calibrated output clock signal; and
a logic device communicatively coupled between the second phase circuit and the clock divider and configured to receive the reference clock signal and a reset signal and generate a synchronized reset signal based on the reference clock signal.

19. The system of claim 18, wherein:
the clock divider of each transceiver is configured to receive the synchronized reset signal; and
the clock divider of each transceiver is configured to generate a divided output clock signal based on the synchronized reset signal and the calibrated output clock signal.

20. The system of claim 19: wherein:
the divided output clock signal for each transceiver is phase aligned with the reference clock signal; and
the synchronization logic is further configured to turn off the reference clock signal after the divided output clock signal is generated.
